(19) United States
(12) Patent Application Publication
(10) Pub. No.: US 2005/0046935 A1
(43) Pub. Date: Mar. 3, 2005

(54) Focal point movement mechanism

(75) Inventor: Takeo Tanaami, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/924,883

(22) Filed: Aug. 25, 2004

(30) Foreign Application Priority Data
Aug. 26, 2003 (JP) 2003-300752

(51) Int. Cl. G02B 21/06

(52) U.S. Cl. 359/380; 359/368

(57) ABSTRACT

The present invention is characterized by the following points: In a focal point movement mechanism for optical microscopes, which moves a focal point position in the optical system where incident light from a prescribed light source is focused on a sample surface using an objective lens, such movement mechanism that is compact and allows high-speed movement of the focal point without affecting samples due to vibration, can be realized by arranging at least one optical element having a positive refractive power and one optical element having a negative refractive power between the objective lens and the light source and by providing a movement means that changes the physical distance between these optical elements.

### BACKGROUND OF THE INVENTION

1. Field of the Invention

The present invention relates to a mechanism for moving the focal point of a microscope and, in more detail, relates to improvement concerning movement of a focal point position at high speed.

2. Description of the Prior Art

A confocal microscope is a type of optical microscope. Confocal microscopes are used for observing physiological reactions and/or the morphology of living cells in the fields of biology, biotechnology, or observation of Large Scale Integration (LSI) surfaces in the semiconductor industry, or the like, because, with a confocal microscope, slice images can be obtained without making thin slices of samples and an accurate three-dimensional solid image of a sample can be constructed.

In confocal microscopes, a focal point position of a light beam is moved to obtain slice images in the direction of sample depth. Focal point movement mechanisms described above include that in which the objective lens is moved in the direction of optical axis using a movement mechanism, and also include that which is equipped with a relay lens between the objective lens and the confocal scanner and the focal point position is moved by moving the relay lens using a movement mechanism (for example, refer to Patent Document 1).

FIG. 1 is a configuration drawing for the focal point movement mechanism mentioned in Patent Document 1 and a confocal microscope using this focal point movement mechanism.

In FIG. 1, the confocal microscope is configured with the combination of confocal scanner part 20 composed of microlens disk 22, pinhole disk 23, beam splitter 25, and lens 26; microscope part 40; and camera 30. The confocal microscope is designed so that a three-dimensional image of sample 11 can be obtained by scanning the sample surface with a light beam using confocal scanner 20 as well as freely moving objective lens 14 in the direction of the optical axis by driving movement mechanism 15.

In such a configuration, laser light 21 is focused at pinhole 24 on pinhole disk 23 through microlenses in microlens disk 22, and after passing pinhole 24, is focused at focal point 13 on scanned surface 12 in sample 11 located at the position optically conjugate with pinhole disk 23 through objective lens 14.

Waveform generator 17 is provided with a waveform data processing means that forms waveform data (for example, a microprocessor), a memory that stores waveform data, and a digital-analog converter that converts waveform data to analog signals. In this case, all of these components are not herein indicated in the drawings.

Movement mechanism 15 is composed, for example, of piezo elements, and is driven by the output signals of driver 16 to move objective lens 14 in the vertical direction. Driver 16 outputs the output waveforms from waveform generator 17 by suitably amplifying them. Although signal waveforms given to driver 16 are triangular waveforms, the waveforms after being subjected to correction for controlling overshoots and/or hunting at the turning points of triangular waveforms are given.

FIG. 2 is a configuration drawing for another focal point movement mechanism mentioned in Patent Document 1 and a confocal microscope using this focal point movement mechanism.

The focal point movement mechanism shown in FIG. 2 is designed to scan the light beam in the direction of the optical axis by arranging relay lens 31 between objective lens 14 in microscope part 50 and confocal scanner 20 in the above-mentioned confocal microscope and causing relay lens 31 to move up and down using movement mechanism 15, driver 16 and waveform generator 17.

Hereupon, conventional microscopes form images directly with the objective lens. Since images are formed at finite distances from the objective lens, these optical systems of microscopes are called the finite system.

However, because the finite system has such problems as generation of aberration, the infinity system has been used. The infinity system is composed of an objective lens which converts light emitted from a body to parallel light beams and a tube lens which makes those parallel beams form an image. In Patent Document 1, although a finite optical system is used as an example in the description, in many cases, infinity optical systems are used in confocal microscopes (for example, refer to Patent Document 2).

Patent Document 1
Gazette for Japanese Laid-open Patent Application No. 2001-51200

Patent Document 2
Gazette for Japanese Patent No. 3294246

In conventional focal point movement mechanisms that move the objective lens, if an attempt is made to move a focal point position at a high speed, vibration becomes large. The problem is less if it is in a dry state in which a space exists between the objective lens and the sample. However, if the sample is immersed in oil or in water, vibration of the objective lens is conducted to the sample through oil or water, causing the sample or the slide glass to move, which is not desirable. In microscopes, a plurality of objective lenses each having different magnification is used generally and piezo elements, which are part of the movement mechanisms, must be attached to each objective lens. This increases the cost, as well as man-power for attaching the piezo elements.

Such problems as described above may be solved by using a confocal point movement mechanism that moves the confocal point by preparing the above-mentioned relay lens. However, it requires twice the distance from the light source to the sample because the relay lens causes an image to be formed once in the microscope, and hence the total length of the microscope becomes longer, which is less practical. In addition, aberration occurs due to the formation of an intermediate image, thus accurate image information cannot be obtained. Further, there is also a problem that the cost is increased because a highly precision lens is required for the relay lens.

### SUMMARY OF THE INVENTION

The present invention intends to solve such problems described above. Accordingly, the objective of the present invention is to offer a mechanism for focal point movement in optical microscopes, which is compact without affecting the sample or the like due to vibration, by equipping at least one optical element having a positive refractive power and one optical element having a negative refractive power between the objective lens and the light source and moving the focal point position by changing the distance between these lenses.

### BRIEF DESCRIPTION OF THE DRAWINGS

FIG. 1 is a configuration drawing of a focal point movement mechanism and a confocal microscope using the mechanism thereof, mentioned in Patent Document 1.

FIG. 2 is a configuration drawing of another focal point movement mechanism and a confocal microscope using the mechanism thereof, mentioned in Patent Document 1.

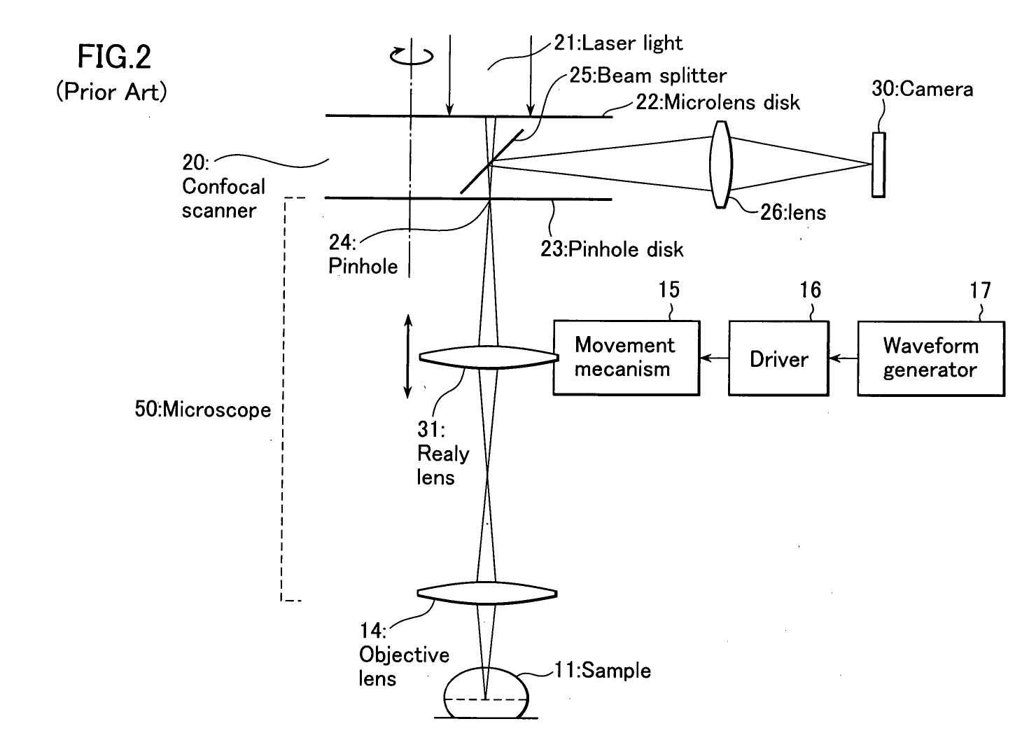

FIG. 3 is a configuration drawing indicating an embodiment of a focal point movement mechanism and a confocal microscope concerning the present invention.

FIG. 4 is a drawing illustrating a focal point movement mechanism of the present invention.

FIG. 5 is a drawing illustrating a focal point movement mechanism in which the present invention is applied to a finite optical system.

### DESCRIPTION OF THE PREFERRED EMBODIMENTS

The present invention will be described below in detail with reference to the drawings.

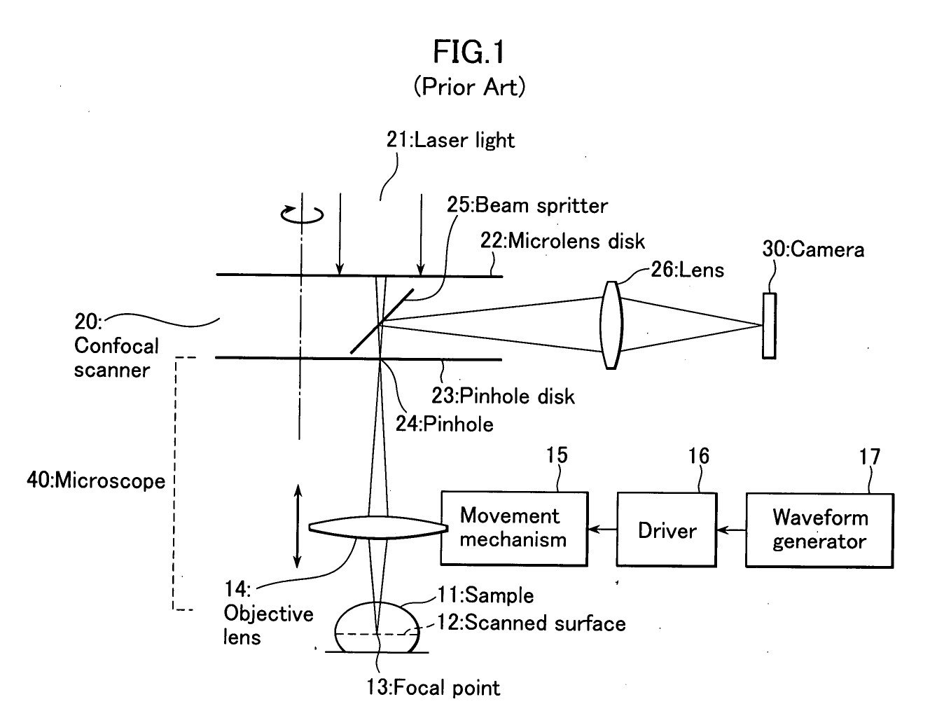

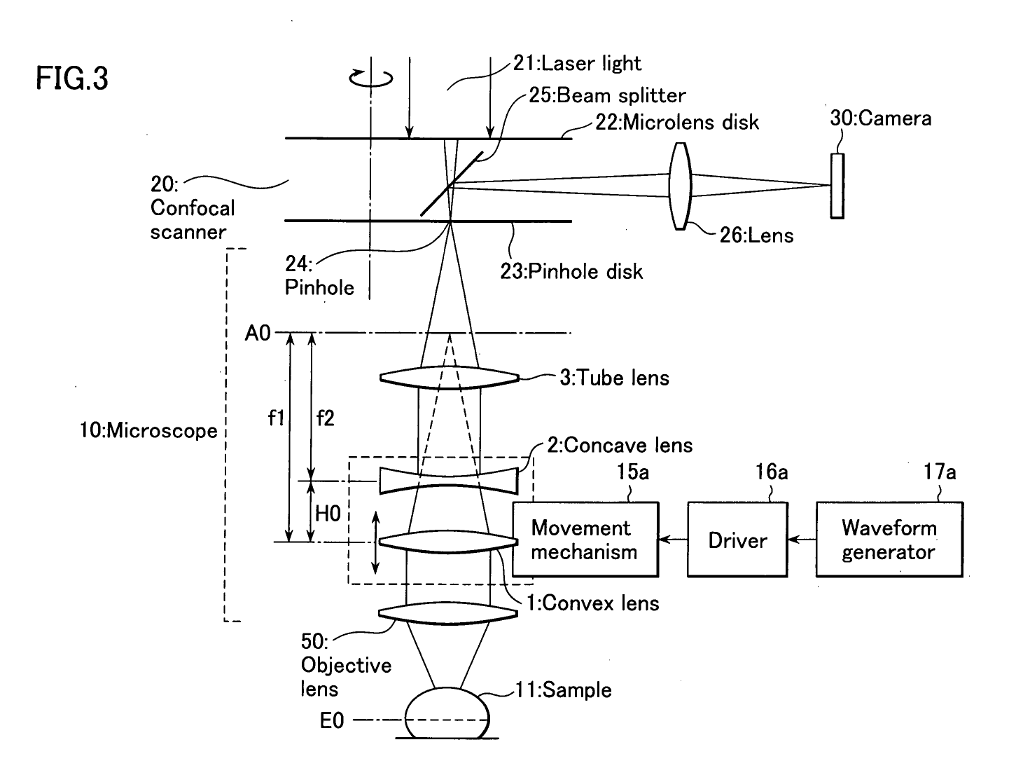

FIG. 3 is a configuration drawing indicating an embodiment of a focal point movement mechanism and a confocal microscope concerning the present invention. In FIG. 3, the same signs are given to the parts equivalent to those shown in FIG. 1, and so their description is omitted.

The configuration shown in FIG. 3 consists of a combination of confocal scanner part 20, microscope part 10, and camera 30. Objective lens 50 is an infinity system objective lens that changes divergent light rays from a point light source to parallel light rays. Tube lens 3 causes the parallel light rays to form an image. Convex lens 1 and concave lens 2 are located between tube lens 3 and objective lens 50. Convex lens 1 shows an example of optical elements having a positive refractive power and concave lens 2 shows an example of optical elements having a negative refractive power. Herein an optical element having a positive refractive power and an optical element having a negative refractive power may be composed of only one lens respectively or may be composed of a group of lenses respectively. In other words, it is sufficient that these light elements can emit the finally outgoing light at an angle of divergence nearly equivalent to that of incidence so that one parallel light is transferred to another parallel light.

Movement mechanism 15a is composed of, for example, a piezo element, driven by the output signal from driver 16a, and causes convex lens 1 to be moved in the vertical direction. Driver 16a outputs the output waveforms of waveform generator 17a after amplifying them suitably. Although the signal waveforms given to driver 16a are triangular, corrected waveforms are given to control the overshoots or hunting at the turning points of the triangular waveforms. Waveform generator 17a is provided with a waveform processing means to form waveform data (for example, a microprocessor), a memory to store the waveform data, and a digital-analog converter to convert the waveform data to analog signals. Herein, all these components will not be shown in the drawing. These are equivalent to movement means.

In such a configuration, in the case where convex lens 1 and concave lens 2 are arranged at distance H0 from each other so that their focal point positions f1 and f2 coincide with point A0, if incident light to concave lens 2 is a parallel light beam, the outgoing light beam from convex lens 1 also becomes a parallel light beam although the beam diameter somewhat changes. Accordingly, focal point position E0 on the sample is the same position as that when convex lens 1 and concave lens 2 are not located.

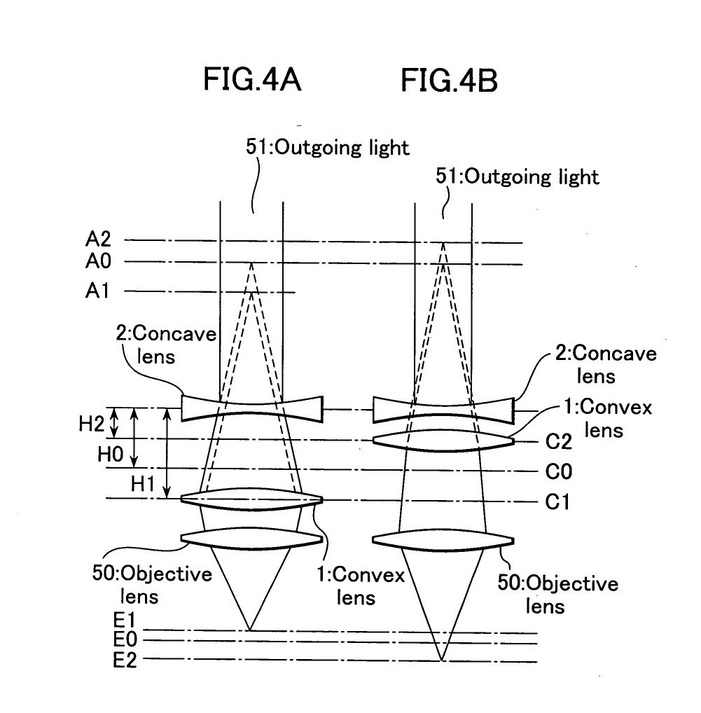

FIG. 4 is a drawing illustrating a focal point movement mechanism of the present invention.

In FIG. 4, outgoing light 51 from the tube lens described above (not shown) is incident to concave lens 2. As shown in FIG. 4A, if distance H0 from convex lens 1 to concave lens 2 is extended to H1 (for example, the position of convex lens 1 is moved from C0 to C1), the focal point position of convex lens 1 moves to a position within the focal length of concave lens 2 because the focal point position of convex lens 1 moves to position A1. This makes the outgoing light of convex lens 1 become a convergent light beam not a parallel light beam, and since this convergent light beam is focused by objective lens 50, the focal point position at the sample moves from E0 to position E1. That is, this is equivalent to an upward direction movement of the focal point position for the optical axis.

On the contrary, as shown in FIG. 4B, if distance H0 from convex lens 1 to concave lens 2 is narrowed to H2 (for example, the position of convex lens 1 is moved from C0 to C2), the focal point position of convex lens 1 moves to a position outside the focal length of concave lens 2 because the focal point position of convex lens 1 moves from A0 to position A2. This makes the outgoing light of convex lens 1 become a divergent light beam not a parallel light beam, and since this divergent light beam is focused by objective lens 50, the focal point position at the sample moves from E0 to E2. That is, this is equivalent to a downward direction movement of the focal point position for the optical axis.

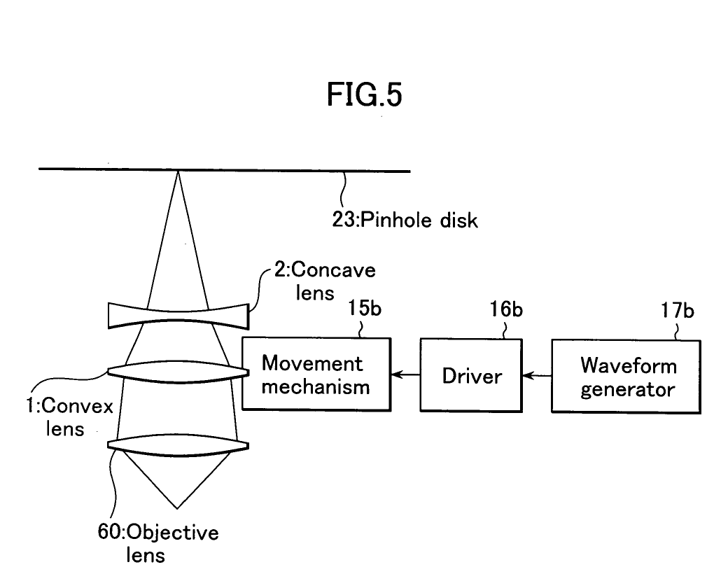

FIG. 5 is a drawing illustrating a focal point movement mechanism in which the present invention is applied to a finite optical system.

In FIG. 5, objective lens 60 is a lens for a finite system. An image obtained by scanning a sample is formed at the position of pinhole disk 23.

In such a configuration, an optical system composed of convex lens 1 and concave lens 2 is provided between pinhole disk 23 and objective lens 60 and a movement means is added to convex lens 1. The configuration for the movement means is similar to that shown in FIG. 3 and so convex lens 1 is moved by movement mechanism 15b, driver 16b and waveform generator 17b. Since this changes the focal point position of convex lens 1, the focal point position at the sample also changes.

However, if such a configuration is adopted, since the distance from objective lens 60 to an image-forming point (position of pinhole disk 23) varies by the thickness of this movement mechanism, correction of length such as shifting the position of the objective lens becomes necessary.

According to the above description, since it is sufficient to move only lenses located within the optical path, not the objective lens itself, a sample is not subjected to vibration even if objective lenses immersed in oil or water are used.

Further, aberration becomes small because the intermediate image forming is not required in amicroscope. It is sufficient for the distance between a convex lens and a concave lens to be several tens of millimeters, thus the present invention is practical as the total microscope length does not need to be changed greatly because these lenses are housed in a compact manner.

Further, this type of microscope equipped with the above mechanism has a spatial margin, and so higher speed operation can easily be obtained, because a large stroke or a large actuator (movement mechanism) can be utilized.

In addition, since the present invention can be effected by only one focal point movement mechanism in the optical path, actuators do not need to be attached to each objective lens, thus greatly improving the cost, as well as man-hours for attaching actuators.

Further, the focal point movement mechanism of the present invention is not only used for confocal microscopes but also can be applied to movement of focal point positions in samples in laser microscopes such as two-photon microscopes, second harmonic generation (SHG) microscopes, Raman microscopes or the like, or in ordinary optical microscopes.

Furthermore, the present invention is not restricted to the above embodiment but may be embodied in other specific forms, changes, and versions without departing from the true spirit thereof.

As described above, the present invention has the following effects:

A focal point movement mechanism and an optical microscope using the mechanism thereof, which is compact and allows high-speed movement of the focal point without affecting samples due to vibration, can be offered by providing at least one optical element having a positive refractive power and one optical element having a negative refractive power between the objective lens and the light source and moving the focal point position by changing the distance between these optical elements.

1. A focal point movement mechanism for an optical microscope, which moves a focal point position in an optical system of the optical microscope where incident light from a prescribed light source is focused on a sample surface using an objective lens, said focal point movement mechanism comprising:
a first optical element having a positive refractive power and a second optical element having a negative refractive power arranged between said objective lens and said light source; and
a movement means which changes the physical distance between said optical elements.

2. A focal point movement mechanism in accordance with claim 1, wherein said optical system is an infinity system or a finite system.

3. A focal point movement mechanism in accordance with claim 1, wherein said first optical element and said second optical element are arranged so that incident light is emitted as outgoing light at an angle of divergence nearly equivalent to that of incidence.

4. A focal point movement mechanism in accordance with claim 2, wherein said first optical element and said second optical element are arranged so that incident light is emitted as outgoing light at an angle of divergence nearly equivalent to that of incidence.

5. A focal point movement mechanism in accordance with claim 1, wherein said optical microscope is a confocal microscope, two-photon microscope, SHG microscope, or Raman microscope.

6. A focal point movement mechanism in accordance with claim 2, wherein said optical microscope is a confocal microscope, two-photon microscope, SHG microscope, or Raman microscope.

7. A focal point movement mechanism in accordance with claim 3, wherein said optical microscope is a confocal microscope, two-photon microscope, SHG microscope, or Raman microscope.

8. A focal point movement mechanism in accordance with claim 4, wherein said optical microscope is a confocal microscope, two-photon microscope, SHG microscope, or Raman microscope.
